(19) United States
(12) Patent Application Publication
(10) Pub. No.: US 2024/0094103 A1
(43) Pub. Date: Mar. 21, 2024

(54) MECHANICAL TESTING OF SAMPLE MATERIALS

(71) Applicant: MRL MATERIALS RESOURCES LLC, Xenia, OH (US)

(72) Inventors: Ayman A. Salem, Beavercreek, OH (US); Michelle Harr, Xenia, OH (US); Adam Pilchak, Xenia, OH (US); Daniel P. Satko, Centerville, OH (US)

(21) Appl. No.: 18/174,507

(22) Filed: Feb. 24, 2023

Related U.S. Application Data
(60) Provisional application No. 63/313,650, filed on Feb. 24, 2022.

(51) Int. Cl. G01N 3/20; G01N 3/06; G06N 3/0455

(52) U.S. Cl. CPC G01N 3/20; G01N 3/068; G06N 3/0455; G01N 2203/0066

(57) ABSTRACT

A process for testing material samples comprises stressing samples under test by bending the samples with a bending fatigue system. During testing, an optical system takes images of the samples and cracks are identified in the samples using the images. Input variables and spatial variables for use in microstructure analysis of the images are determined and used to create a model. Based on the model, crack growth rates are predicted for untested microstructures based on the samples based on the analysis of the images.

### CROSS REFERENCE TO RELATED APPLICATIONS

This application claims the benefit of U.S. Provisional Patent Application Ser. No. 63/3131,650, filed Feb. 24, 2022, and having the title “MECHANICAL TESTING OF SAMPLE MATERIALS”, the disclosure of which is hereby incorporated by reference as if expressly set forth in its entirety.

### STATEMENT REGARDING FEDERALLY SPONSORED RESEARCH OR DEVELOPMENT

This invention was made with government support under SBIR/STTR contract No. N68335-19-CO-368 awarded by the Navy. The government has certain rights in the invention.

### BACKGROUND

Various aspects of the present invention relate generally to fatigue testing of sample materials using mechanical bending, and more specifically to testing multiple samples simultaneously.

Material testing can take various forms. For instance, fatigue test can be accomplished by applying axial loads repeatedly for a predetermined number of “cycles”. In this regard, such cyclic testing can be categorized as low-cycle, high-cycle, or ultra-high-cycle testing based on the number of cycles necessary to cause a material to fail.

### BRIEF SUMMARY

According to aspects of the present invention, process for testing material samples comprises stressing samples under test by bending the samples with a bending fatigue system. During testing, an optical system takes images of the samples and cracks are identified in the samples using the images. Input variables and spatial variables for use in microstructure analysis of the images are determined and used to create a model. Based on the model, crack growth rates are predicted for untested microstructures based on the samples based on the analysis of the images

### BRIEF DESCRIPTION OF THE SEVERAL VIEWS OF THE DRAWINGS

FIG. 1 is a graph illustrating sample fatigue testing under low cycle, high cycle, and ultra-high cycle fatigue, according to various aspects of the present disclosure;

FIG. 2 is an illustration of a flat sample for test, according to various aspects of the present disclosure;

FIG. 3 is a system overview of a fatigue system, according to various aspects of the present disclosure;

FIG. 4 is a flow chart illustrating a process for testing material samples to predict lifetime of manufactured components, according to various aspects of the present disclosure;

FIG. 5 is a graph illustrating crack growth, according to various aspects of the present disclosure;

FIG. 6 is a backscattered image of microstructures in a sample, where the microstructures are illustrated in different colors, according to various aspects of the present disclosure;

FIG. 7 is a block diagram of a computer system for implementing processes for analyzing and predicting lifetime of manufactured components, according to various aspects of the present invention as described in greater detail herein.

### DETAILED DESCRIPTION

Aspects of the present disclosure improve the field and technology of fatigue testing of materials by implementing a novel high throughput, multi-sample test process that can be used with standard single sample test processes. Further, apparatuses are disclosed herein that can be used to implement the high throughput, multi-sample test processes herein. The processes and apparatuses herein can be used to not only test traditional materials, but additive manufacturing (AM) parts as well.

Qualification of materials for aerospace use and other sensitive industries is a lengthy process involving extensive testing to develop rigorous, statistical limits on the expected variation in sample material properties. Qualification testing is done in order to enable designers to limit applied loads to an extent that will produce known factors of safety and ensure part performance in the face of manufacturing variability.

For example, in aerospace materials, the standard for design is the Metallic Materials Properties Development and Standardization (MMPDS) Handbook. The MMPDS is used by both military and commercial aerospace industries around the world. Two of the most common properties of interest in designing parts are tension and fatigue testing. The MMPDS recommends that full stress-life (S-N) curves be generated at three different stress ratios and be generated in triplicate (i.e., completed three times), which can take a tremendous amount of time (e.g., weeks/months) and money.

When a fatigue test is performed on a given material, designers of the given material will may utilize stress-life (S-N) curves to analyze how the given material handles varying amounts of load. Fully characterizing the material for fatigue life involves finding a number of repeated loading cycles before failure (N_{f}), eventually finding endurance limit of the material for a given amplitude, mean value, and control mode.

Additional factors that may require further consideration are present when dealing with additive manufacturing (AM) materials. In some cases, variation in additive manufacturing due to changes in material, thermal profile, random defects, etc. is more common than found in conventional manufacturing processes. Even non-processing parameter design decisions, such as part orientation and support structures can significantly impact properties in AM materials.

For example, a number of “product forms” for additive manufacturing virtually is unlimited, thus making qualification of AM materials by standard methods challenging. Accordingly, it is clear that a high-throughput testing method that matches the needs of AM for agility and design is needed. Additionally, as new materials are being developed and are candidates for use in various applications (e.g., aerospace), there is a need for increased speed in carrying out these tests to make the speed of qualification to match the speed of innovation in AM.

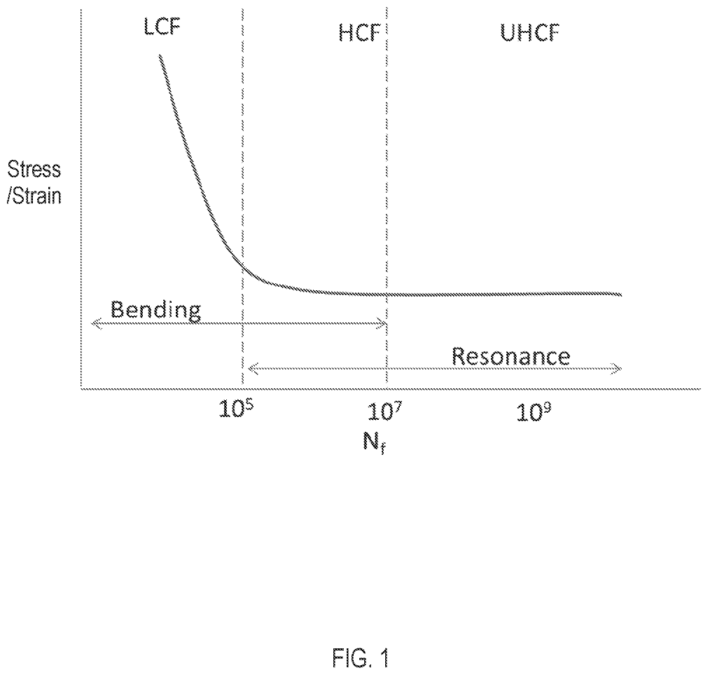

Now referring to the figures, and specifically to FIG. 1, a simple S-N curve is illustrated. In a typical S-N curve, it is recommended that three different stress ratios are used for testing. Generally, the stress ratios are classified as low-cycle fatigue (LCF), high-cycle fatigue (HCF), and ultra-high-cycle testing (UHFC). LCF tests are usually limited to less than 10⁵ (i.e., 100,000) cycles, HCF tests are usually between 10⁵ and 10⁷ (i.e., 10,000,000) cycles, and UHFC tests are over 10⁷ cycles (e.g., 10⁹, or 1,000,000,000 cycles). However, these classifications are merely illustrative, and can vary.

As shown in FIG. 1, at an initial portion of the curve, a material tested at higher stress/strains induces localized plastic deformation with each cycle, which causes the material to fail with fewer cycles (e.g., LCF), thus resulting in a steep drop-off in the fatigue curve. As the endurance limit is reached, the stress/strain applied is much closer to the true elastic limit for deformation, thus requiring a significantly larger number of cycles (e.g., HCF) for the material to fail as cracks either fail to nucleate or microcracks nucleate near local discontinuities but lack sufficient driving force to grow. Additionally, some materials do not show a true endurance limit in the sense of infinite life, but the maximum stress decreases with life out to the ultra-high cycle regime (around 10⁹ cycles and beyond).

To fully test a material, the material should be tested within each stress ratio (e.g., LCF, HCF and UHCF). Two tests that can be used in fatigue testing are a “bending test”, where a material is mechanically bent repeatedly (e.g., a mechanism is fixed to the end of the material and moves axially, thus bending the material), and “resonance bending”, where the material is vibrated at a high frequency and the material bends under its own weight. By nature, the resonance bending test can complete more cycles in a shorter time than the bending test. Thus, the bending test is usually for testing in the LCF-HCF ranges, while the resonance test is used for the HCF-UHCF ranges as shown in FIG. 1.

Aspects of the present disclosure provide numerous advantages over existing solutions. For example, the fatigue sample geometry lends itself to additive manufacturing with various combinations of orientation and/or thermal profiles and requires fewer machining operations when compared to existing solutions.

Moreover, higher throughput of samples can be achieved by parallelizing testing of multiple samples using a single apparatus. In this regard, using a single apparatus for testing multiple samples simultaneous also yields more consistent results.

Further, aspects of the present disclosure allow for simplification of characterization for insertion into materials models as well as favorable comparison to existing testing standards (e.g., ASTM E8 and E466).

Example Fatigue Sample Design

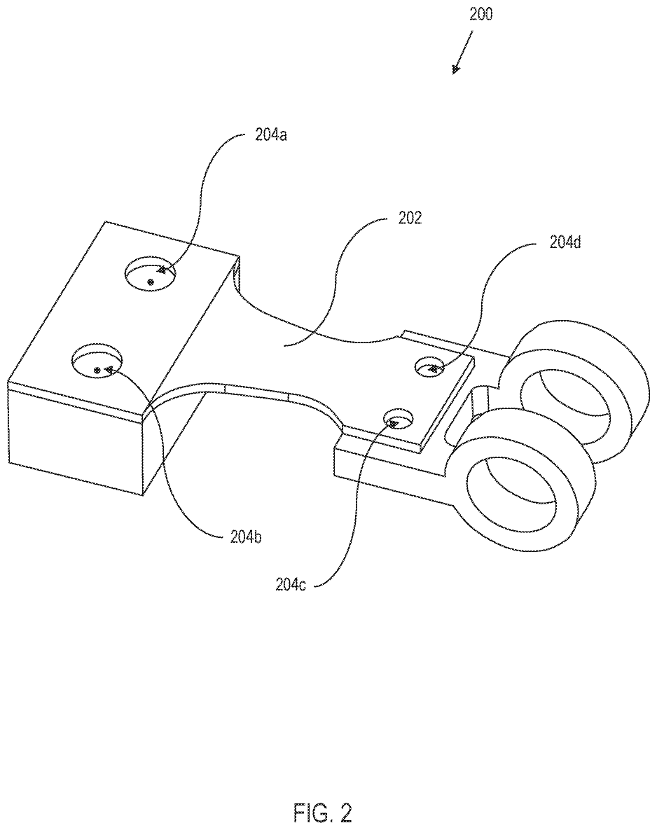

In typical load controlled axial fatigue tests, a cylindrical sample is used. Unconventionally, aspects of the present disclosure are directed toward a cantilever-type sample, which yield numerous advantages over the cylindrical sample. Referring to FIG. 2A, an example 200 of the cantilever-type sample 202 (hereinafter “sample”) for use in the systems and processes herein is illustrated.

In various embodiments, the sample 202 comprises one or more anchor points 204a-d that can be used to fasten the sample to various testing apparatuses, or attaching components (e.g., weights) to the sample 202 itself, as described in greater detail herein. The sample 202 has numerous advantages over cylindrical samples. For instance, the sample 202 is not as complex from a standpoint of fabrication in both conventional materials as well as AM materials.

For example, the sample 202 can be printed as a block that can be quickly and accurately sectioned using wire electrical discharge machining (EDM). The EDM is a machine that can be remotely programmed and run unattended using G-codes (e.g., preset actions that are coded), and is faster than many current mechanical cutting methods.

Using the block to create one or more samples 202 also allows for analysis of manufactured variability of the sample(s) based on position in the block, thus allowing for the understanding of how characteristics of a solid piece will behave due to variation in thermal profiles. Samples 202 can be printed net profile or cut from thicker blocks to test different microstructures, and the thickness of the block can be varied according to the target thermal profile.

Creation of the block can be accomplished using a variety of techniques such as laser powder bed fusion from a variety of materials, including Ti6Al4V, aluminum alloy AddAlloy HX, and 316L and 17-4PH stainless steel (with or without H900 treatment).

By using geometries like the sample 202 (i.e., flat samples) instead of round or cylindrical samples, time and energy invested in sample fabrication drastically decreases. By way of example, a typical process for production of a cylindrical fatigue test specimen includes: coring/extracting cylindrical blanks from the given material, rough turning to initial shape, fine turning to a slight oversize with successively finer cuts to reduce deformation, rough grinding to near-net shape over multiple passes, followed by low-stress grinding to final shape by multiple passes, then manual polishing of the gage section to achieve longitudinal orientation of all machining marks. Thereafter, electropolishing may be required depending on testing metrics, followed by testing of the cylindrical sample. Moreover, such a process typically only produces a single sample per machine at a time.

Conversely, when producing flat bending samples, a general profile can be cut and samples sliced off in the EDM machine to produce a stack of samples. The stack of samples can then be lapped in a batch process of many samples at a time, followed by grinding away EDM remnants, which can alternatively be accomplished by pickling or electrochemical machining prior to lapping, again as a batch process. Thereafter, electropolishing can be performed if desired, followed by testing. As an added benefit, the production of the flat bending specimens, including testing thereof, can be parallelized to achieve a high throughput.

Time taken to produce such samples is significantly reduced by virtue of making more than one sample at a time.

Another advantage of flat samples over cylindrical examples is that since known locations of high stress are on a planar surface, flat samples can easily be prepared and examined by SEM, light microscopy, etc. Such analysis is not possible using a cylindrical axial specimen. The flat surface also lends itself to characterization of the microstructure (including defects) in the high-stress areas and to the tracking of crack growth, as described in greater detail herein.

Fatigue Testing

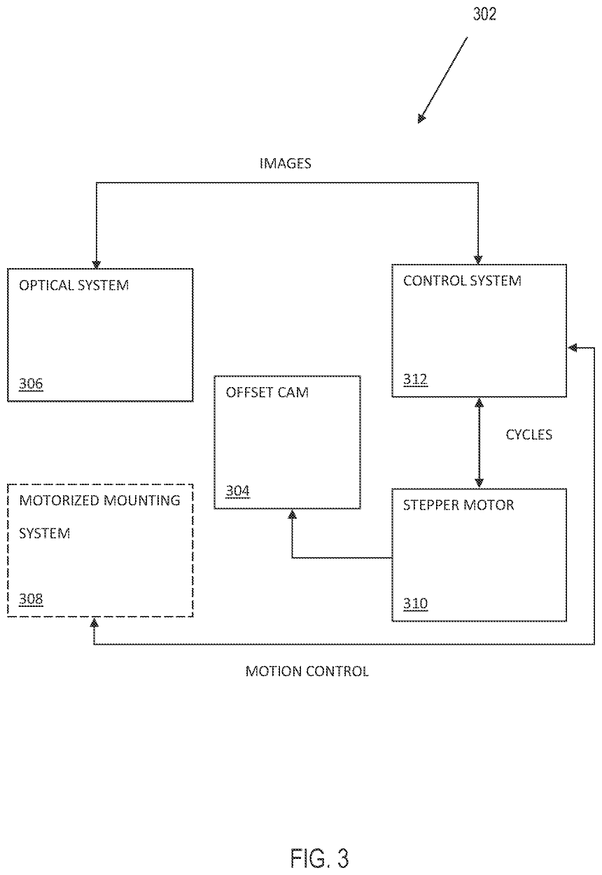

Aspects of the present disclosure are directed toward a loading apparatus which can be used for high throughput production of low cycle fatigue (LCF) data. The apparatus can accommodate multiple flexural fatigue samples 202 which are attached to a loading apparatus, which reciprocates sample material(s) for a predetermined number of cycles as described herein. Turning to FIG. 3, flat samples, discussed herein, may be tested based on mechanical bending using a bending fatigue system 302. The basic design of the bending fatigue system is an offset cam 304 in a bearing that drives vertical motion of a push arm via the rocker arm that the bearing is placed in, which serves as a lever. A second, vertically and horizontally adjustable push arm anchors the rear of the rocker arm to the base to allow for the adjustment of both and amplitude and offset of the forced displacement experienced by the sample. Eccentricity is still able to be adjusted to provide a scalable factor to stroke length but will require the swapping of a cam insert inside the bearing. It can be seen that by adjusting the relative ratio of the length of the lever arm (L₁,L₂) from with respect to the eccentric (e), the stroke (s) can be dynamically varied according to:

$$\frac{e}{{l}_{2}} = \frac{s}{{l}_{1} + {l}_{2}} \qquad ( 1 )$$

where e is the fixed eccentric, s is the amplitude of the sample displacement and l1 and l2 are the lever arm lengths nearer and farther from the sample, respectively. This is accomplished by adjusting the position of the rear pivot point (i.e., changing l2).

Likewise, the offset (i.e., stress ratio) of the sample displacement is adjusted by vertical displacement of the ground link. The relationship of this displacement to the offset of the sample displacement is governed by:

$$\frac{{O}_{p}}{{l}_{2}} = \frac{{O}_{s}}{{l}_{1}} \qquad ( 2 )$$

where O_{P} and Oₛ are the offset in the pivot and sample, respectively.

A sensor (e.g., laser profilometer, strain gauge, electron microscope, etc. or combinations thereof) measures surface curvature of a sample under test during testing.

Further, an optical system 306 may be used to take images of the samples in various states to try to identify cracks in the samples. In some embodiments, the optical system is attached to the body of the bending fatigue system and includes a 10× Mitutoyo microscope lens, microscope body, high-resolution camera (24.5 megapixels). In numerous embodiments, the optical system includes a field of view of about 1.6 millimeters and a resolving power of about 0.3 micrometers. In various embodiments, then optical system may be positioned anywhere in three dimensions around the bending fatigue system (e.g., via multiple automated stages 308 for full X, Y, Z motion).

A stepper motor 310 rotates an arm of the bending system to allow for fatigue cycling and for precise, repeatable stopping at a desired angle of bend on the samples (i.e., the same bending applied to the samples for imaging). The desired bend angle may be user defined (e.g., approximately 80% of maximum displacement) to mimic a standard load for crack measurement techniques (e.g., acetate replicas). However, the desired bend angle may be based on a maximum load for a particular application of devices that the samples are based upon.

A control system 312 includes a user interface that allows a user to define a total number of cycles, a number of cycles between imaging, a number of images to take, an amount of adjustment (e.g., movement) of the optical system for a next image to be taken, etc. For example, multiple images at different focal lengths (i.e., z positions of the optical system) may be taken to help ensure that any crack in an area of interest is in focus. Further, the optical system may be moved in other directions (x, y) to create a stitched montage of images over the sample, which may be required when cracks (areas of interest) are longer than a field of view of the optical system.

In some embodiments, the samples are notched, scored, otherwise stressed (or combinations thereof) at a desired location, so a crack will initiate at the location. This allows the optical system to know a starting location for images to identify cracks in the samples. However, using multiple images (as discussed above), a stitched montage can be created to find any naturally occurring cracks (i.e., cracks not at the desired location). Thus, the stitched montage allows for identifying defects in additively manufactured materials with pore and other possible printing defects and for observation of multiple cracks and any evolution of the cracks over time.

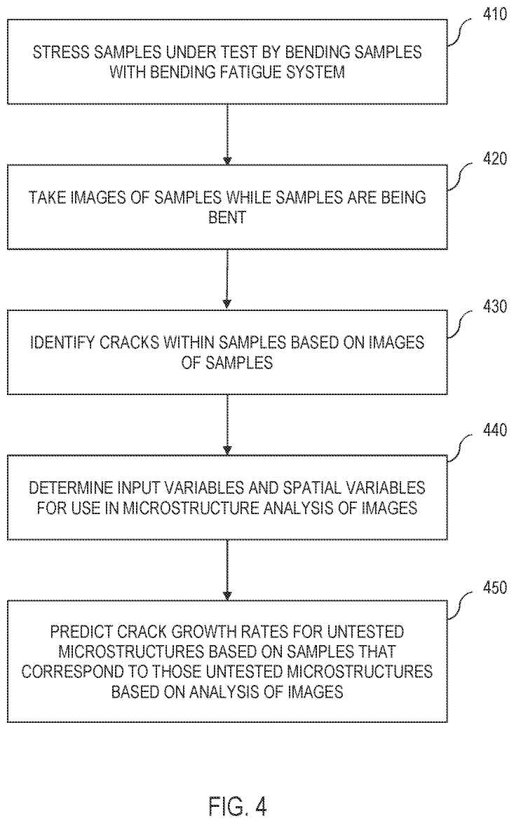

Turning to FIG. 4, a flow chart 400 is shown that illustrates a process for predicting component lifetime of additive-manufactured devices using testing devices as described herein. To predict possible failures, at 410, samples under test are subjected to bending (e.g., by the bending systems described herein), and at 420 images are taken of the samples at various points during testing. For example, the images may be taken with an optical system while the samples are held stationary for an image, the images may be taken while the samples are moving (actively changing bending angles), or combinations thereof (at different points in time). As discussed herein, multiple images may be taken to ensure that any cracks are in focus and to stitch together a montage of images to get a larger field of view.

At 430, the images are then used to identify cracks in the samples, lengths of the cracks, and shapes of the cracks.

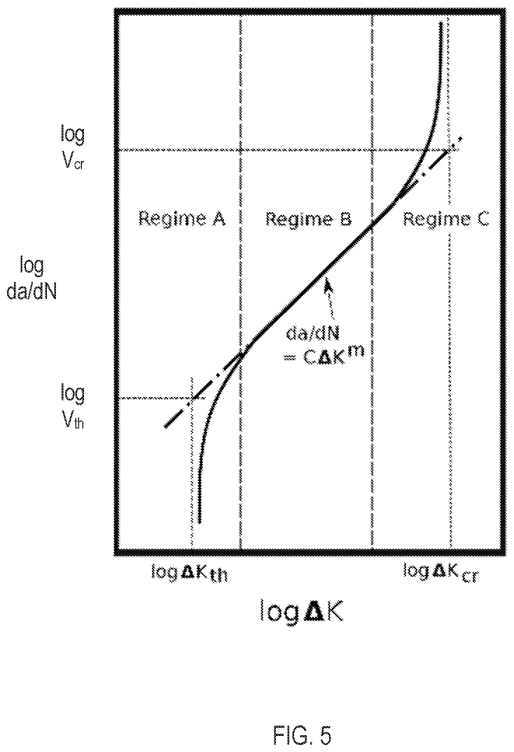

At 440, input variables and space variables are determined for analysis. For example, current methods use a traditional crack-growth curve expressed in Linear Elastic Fracture Mechanics (crack growth rate (da/dN) vs. stress intensity factor (ΔK)). Typically, the curve is fit using Paris Law to generate two fit variables (e.g., Paris Fit variables, C and m), as shown in FIG. 5. Further, parameters other than the Paris Fit parameters (e.g., Walker equations, Foreman equation, etc.) may be used as well.

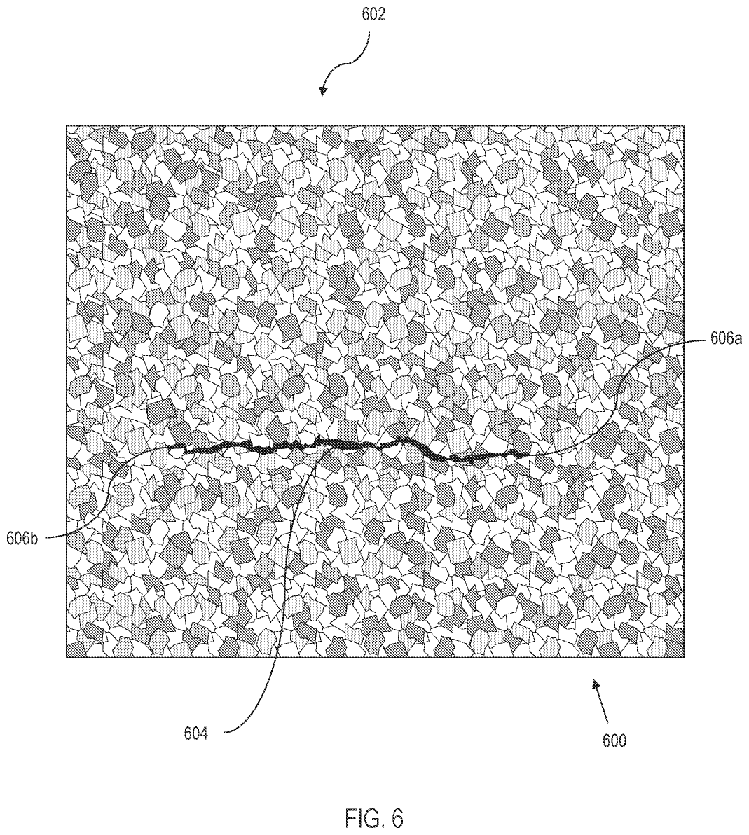

Another method that may be used makes use of spatially resolved crack optical images and orientation information to observe an effect of microstructure regions on ends of the cracks (i.e., tips of the cracks). The microstructure regions help illustrate how the crack interacts with metal grains in the sample, boundaries, and orientations (e.g., with other microstructure regions). Further, the microstructure regions also help predict an effect of the crack on a longer-range neighborhood of microstructures. More information on microstructure regions can be found in U.S. Pat. No. 9,070,203 entitled Identification and Quantification of Microtextured Regions in Materials with Ordered Crystal Structure filed Feb. 7, 2013 by Salem, et al., the entirety of which is hereby incorporated by reference. For example, FIG. 6 is an image 600 of an electron backscatter diffraction (EBSD) orientation data of a sample 602 that shows a segmented crack 604 from an image, where the crack 604 has tips 606a, 606b and grains are shown in different colors. The microstructure may be characterized by the methods described in U.S. Pat. No. 9,070,203.

Another method that may be used in conjunction with the identification of microregions discussed above is using polarized light and/or backscatter electron images from a scanning electron microscope to characterize the microstructure. Such methods and systems are described in greater detail in U.S. patent application Ser. No. 16/431,161 entitled Analyzing Microtextured Regions of Optically Anisotropic Materials filed on Jun. 4, 2019 by Satko et al., the entirety of which is hereby incorporated by reference.

At 450, neural networks (e.g., Bayesian, Physics Informed, autoencoder, etc., combinations thereof) are used to correlate and cluster the input parameters to predict and interpolate crack growth rates for untested microstructures. For example, a very large dimensional space (e.g., hundreds of dimensions) is used to train the neural networks (e.g., the BNN and the autoencoder), and includes alloy type, microstructure parameters (e.g., two-point statistics at the crack tip, two-point statistics within a larger neighborhood, generalized spherical harmonic at various length scales, chord length distribution, etc.), sample heat treatment, sample surface finish, residual stresses, orientation of the sample (e.g., rolling direction, transfer direction, etc. from a rolled plate), post sample heat treatment and processing, test stress ratio, crack growth rate (da/dN), and stress intensity factor (ΔK). Thus, a predictive model is created.

Input to the predictive model includes the large dimensional space (as discussed above, except crack growth rate information) for the model to interpolate and output crack growth rate and stress intensity factor for the untested microstructure using a physical structure to understand effects of microstructure, test design and sample processing ranging from atomistic crack tip level, to structural microfeatures (i.e., regions of microtexture), to the component level. Thus, crack growth rate may be predicted hierarchically through the atom level at the crack tip, through the defined microstructure regions, through to the component itself. The predicted crack growth rate can be used to predict a final lifetime for the component with similar parameters set by the very large dimensional space. With greater understanding of these models and the interactions between the variables/parameters, the large dimensional space may be reduced.

### Advantages

The processes and apparatuses herein provide numerous benefits over existing solutions. For instances, apparatuses and processes herein allow for testing of multiple samples simultaneously (or in parallel) as opposed to testing one sample at a time. Moreover, in addition to testing multiple sample materials at the same time, testing is accomplished up to 60× faster than existing solutions.

Further, utilizing flat geometry as the sample material allows for easier fabrication of the sample material by creating the sample material from blocks. In addition, taking multiple samples from a single block allows for a greater consistency between sample materials, and allows a user to conduct more fined tuned analysis of sample materials based where the sample material was cut from the block. The flat geometry also allows a user to conduct testing using recognized testing standards (e.g., ASTM B593).

Yet further, by using resonance testing for HCF and UHCF cycles plastic deformation due to heat can be reduced or eliminated.

Aspects of the present disclosure enable additive manufacturing (AM) part certification and AM process qualification for limited production lots and large lots and are also applicable to net shape samples printed concurrently with a part to be tested to capture an effect of as-built surface roughness on the mechanical behavior. Further, flat sample designs are disclosed herein allow for fatigue testing is sensitive to effects from surface volume of the sample. Thus, effects of bulk defects can be eliminated to generate robust data for validating lifting models of AM parts as a function of surface condition.

Aspects of the present disclosure also address a major problem of certifying and qualifying parts/processing of metallic additive by harvesting the flexibility to tailor processing conditions, microstructure, and even chemistry in a location-specific manner, to enable feature specific high throughput mechanical testing (“HTMS”) testing (e.g. surface roughness, subsurface defects, thin section microstructure etc.). Combined with model-based and/or data-driven pattern recognition, HTMS can be used to rapidly ascertain inherent process variability, effect of process changes (e.g., part orientation), and uncertainty due to defects if combined with microstructure/defect quantification.

### MISCELLANEOUS

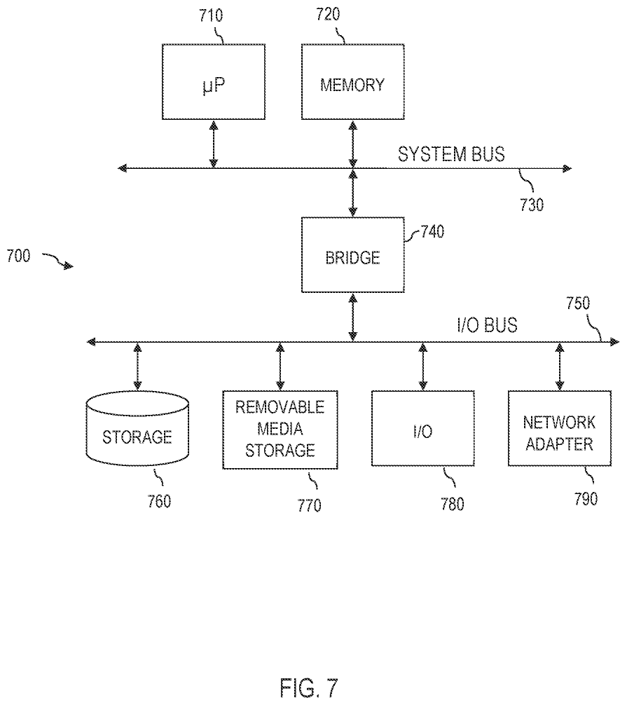

Referring to FIG. 7, a block diagram of a data processing system (i.e., computer system) is depicted in accordance with the present invention. Data processing system 800 may comprise a symmetric multiprocessor (SMP) system or other configuration including a plurality of processors 810 connected to system bus 830. Alternatively, a single processor 810 may be employed. Also connected to system bus 830 is local memory 820. An I/O bus bridge 840 is connected to the system bus 830 and provides an interface to an I/O bus 850. The I/O bus may be utilized to support one or more buses and corresponding devices 870, such as storage 860, removable media storage 870, input output devices (I/O devices) 880, network adapters 890, etc. Network adapters may also be coupled to the system to enable the data processing system to become coupled to other data processing systems or remote printers or storage devices through intervening private or public networks.

Also connected to the I/O bus may be devices such as a graphics adapter, storage and a computer usable storage medium having computer usable program code embodied thereon. The computer usable program code may be executed to implement any aspect of the present invention, for example, to implement any aspect of any of the methods and/or system components described herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using an Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for testing material samples, the method comprising:
configuring a bending fatigue system to perform fatigue testing on a material sample;
acquiring, with an optical system, at least one image of a location of interest within the material sample, the location of interest corresponding to a crack that either (i) initiates as a result of the performed testing or (ii) is introduced into the material sample prior to the performed testing;
determining crack growth parameters of the location of interest from the acquired at least one image;
characterizing microstructure parameters of the location of interest from the acquired at least one image;
correlating the crack growth parameters and microstructure parameters; and
determining a component lifetime using a predictive model on the correlated crack growth parameters and microstructure parameters.

2. The process of claim 1, wherein the bending fatigue system includes the topical system.

3. The process of claim 1, wherein the creating crack growth parameters comprises creating a crack growth curve and Paris fit parameters.

4. The process of claim 1, wherein the predictive model comprises a machine learning model.

5. The process of claim 4, wherein an algorithm used to create the machine learning model comprises a classification algorithm.

6. The process of claim 5, wherein the classification algorithm comprises a neural network.

7. The process of claim 6, wherein the neural network is selected from the group consisting of an autoencoder, a convolutional neural network and a deep learning network.

8. The process of claim 5, wherein the classification algorithm is selected from the group consisting of instance-based algorithms, Bayesian-based algorithms, dimensionality reduction algorithms, support vector machine algorithms, decision tree algorithms and ensemble-based algorithms.

9. The process of claim 8, wherein the instance-based algorithm comprises a k-nearest neighbor algorithm.

10. The process of claim 8, wherein the Bayesian-based algorithm comprises at least one of naïve Bayes, Bayesian belief, Bayesian linear regression and dynamic Markov-based algorithms.

11. The process of claim 8, wherein the ensemble-based algorithm comprises at least one of random forests, boosting and bootstrap aggregating algorithms.

12. The process of claim 8, wherein the decision tree algorithms comprise a regression tree algorithm.

13. The process of claim 8, wherein the dimensionality reduction algorithms comprise at least one of principal component analysis and linear discriminant analysis.

14. The process of claim 1, wherein the predictive model predicts at least one of fracture and fatigue analysis for the material sample.

15. The process of claim 14, wherein the fracture analysis comprises a ductile fracture analysis.

16. The process of claim 14, wherein the fracture analysis comprises a brittle fracture analysis.

17. The process of claim 16, wherein the brittle fracture analysis comprises analyzing stress concentration factors.

18. The process of claim 14, wherein the fracture analysis comprises a fracture toughness analysis.

19. The process of claim 14, wherein the fatigue analysis comprises generating at least one of a stress-strain curve, an endurance limit curve, and a Goodman curve.

20. A process for testing material samples, the method comprising:
stressing samples under test by bending the samples with a bending fatigue system;
taking images of the samples while the samples are being bent;
identifying cracks within the samples based on the images of the samples;
determining input variables and spatial variables for use in microstructure analysis of the images; and
predicting crack growth rates for untested microstructures based on the samples based on the analysis of the images.
